(19) United States
(12) Patent Application Publication
(10) Pub. No.: US 2010/0071142 A1
(43) Pub. Date: Mar. 25, 2010

(54) 2-SPEED TOOTHBRUSH

(76) Inventors: David J. Boll, Avon, OH (US); Hoke Vogler Bullard, III, Chatham, NJ (US)

Correspondence Address: CHURCH & DWIGHT CO., INC., LAW DEPT. - PATENTS, 469 NORTH HARRISON STREET, PRINCETON, NJ, 08543-5297, US

(21) Appl. No.: 12/517,212

(22) PCT Filed: Dec. 5, 2007
(86) PCT No.: PCT/US07/86522

§ 371 Date: Jun. 30, 2009

Related U.S. Application Data
(60) Provisional application No. 60/872,972, filed on Dec. 5, 2006.

(51) Int. Cl. A46B 13/00; H02P 7/14; A46B 9/04

(52) U.S. Cl. 15/22.1; 388/827; 15/167.1

(57) ABSTRACT

A circuit for varying the speed of a variable speed motor having a power source to provide a voltage to the motor and a diode as a means to provide a voltage drop within the circuit that is substantially independent of the amount of current to the motor. The invention may further comprise an electric toothbrush using the circuit.

### REFERENCE TO RELATED APPLICATIONS

This application is related to U.S. Provisional Application Ser. No. 60/872,972 filed Dec. 5, 2006, and takes priority therefrom.

### FIELD OF THE INVENTION

The present invention is directed to a novel circuit for varying the speed of a battery-operated motor. The variable speed motor has use in household appliances such as electric toothbrushes, for example.

### BACKGROUND OF THE INVENTION

Conventional devices for oral cleansing have ranged from the traditional manual toothbrush to electric devices. For instance, electric toothbrushes such as those with axial and lateral oscillating or rotating brushes have been used to stimulate the up and down, back and forth strokes of a manual toothbrush. These devices are typically powered by rechargeable, though somewhat short-lived, battery packs and/or tethered electrical cords.

Despite the many technological advances in electronic teeth cleaning apparatus, the old fashioned, manual toothbrush remains the most popular method for cleaning teeth. This is believed due not only to its simplicity, practicality, disposability and cost, but also its many design innovations ranging form new bristle materials and patterns, to angled brush heads and contoured brush handles. Its effectiveness, however, still depends in large part, on the skill and vigilance of the user. Steadily increasing costs have lead most users to use the same toothbrush well beyond its intended design life. The resulting worn brush with characteristic bowed bristles is not only unsanitary, but also has significantly reduced debris removal capability, particularly for removal between teeth and below gums.

A toothbrush is therefore desired which not only provides superior cleaning of teeth and gums with minimal effort of the user, but is also safe, practical, convenient and inexpensive.

A particular advantage of manual toothbrushes is that the user can control the speed and pressure of the brushing action. A typical electric toothbrush has only one speed and, often, increasing pressure of the brush on the teeth can adversely affect the internal structure of the electric toothbrush including gearing and moving linkage structures and ultimately harm the motor itself.

It is known to provide variable speed motors into electric toothbrushes and utilize a switching system to provide, for example, two power settings to control the speed of the electric motor. Such devices typically utilized multiple switches and one or more resisters to control the current to the motor and thereby vary the speed of the motor depending on which switch is selected. The voltage drop across a resistor is proportional to the current through it, according to Ohm's law. Thus, as the motor is more heavily loaded, it draws more current and accordingly the drop across the resister will increase and the motor will slow still more.

Further, during the life of the battery, the voltage will fluxuate as the battery ages, and accordingly, the desired speed of the oscillating or rotating motion of the brushes will not be consistent throughout the life of the battery.

While the discussion herein will be directed to use of battery operated motors in electric toothbrushes, the invention here is to be construed more widely as the circuit provided herein to vary the speed of a battery operated motor is not limited to merely electric toothbrushes but is more generally concerned with battery operated motors for any type device. For example, electric shavers and like devices are uses for the present invention.

### SUMMARY OF THE INVENTION

In accordance with the present invention, a circuit for changing the speed of a battery-operated motor is provided in which the voltage drop used to reduce the motor speed is largely independent of the motor current. In the present invention, a circuit is used in which a diode is used instead of a resistor for the voltage-dropping device. In as much as the voltage drop through the diode is not dependant on the current, consistent speeds can be provided by the motor throughout the operational life of the battery. The circuit of the present invention has particular use in electric toothbrushes but as before said, is not to be construed to be limited to such uses.

### BRIEF DESCRIPTION OF THE DRAWINGS

FIG. 1 is schematic view of the interior of an electric toothbrush.

FIG. 2 is an electronic schematic diagram for the two speed motor operation of the present invention.

### DETAILED DESCRIPTION OF THE INVENTION

The present invention will be described with respect to the use of a two speed battery-operated motor in an electric toothbrush. Again, it is to be understood that other devices powered by a battery-operated motor can be provided with the unique circuit of this invention.

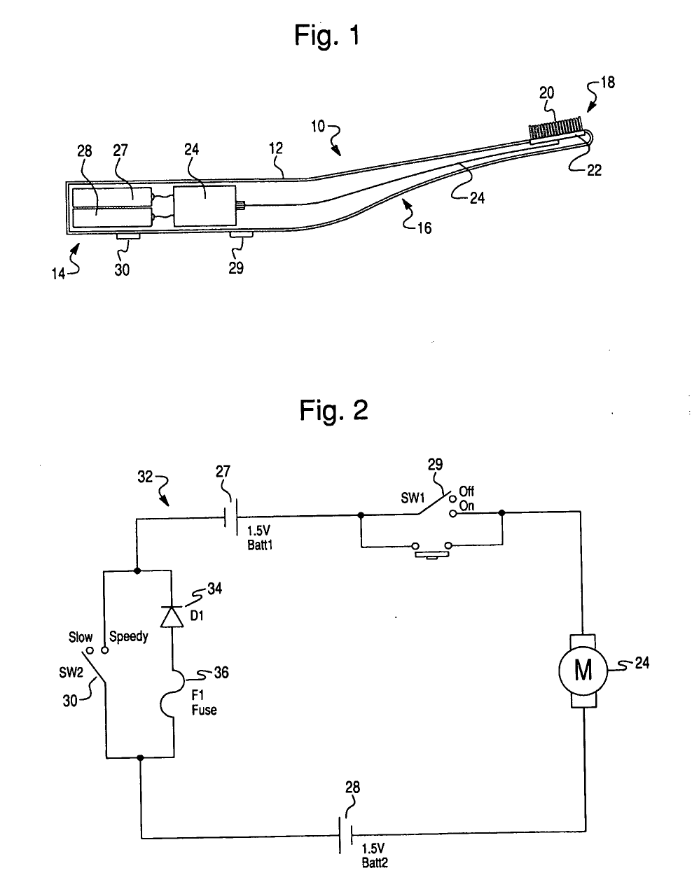

In accordance with FIG. 1, a motorized toothbrush 10 includes a housing 12 with a handle portion 14, a neck 16 and a head portion 18. The head portion 18 contains bristles 20 which are typically supported by a brush plate 22. A variable, high-speed motor 24 is provided for effecting oscillation or rotation of the brush plate 22 or bristles 20. In general, some type of linkage 24 between the motor and the brush plate 22 or brushes 20 converts the rotation of the motor 24 into the movement of brush plate 22 and/or bristles 20. It is not within the scope of the present invention to limit the type of movement of the bristles 20 or the type of linkage and linkage structure which is used to move the bristles 20 by the rotation of the motor 24. Accordingly, any and all types of movements including axial lateral movement, linear movement which is perpendicular to the axis of the brush or even rotation of the brush plate 22 or groups of bristles 20 contained in the brush head are all within the scope of the present invention. Operation of the motor is provided by power such as, for example, batteries 27 and 28. The power source although shown as two batteries can be provided by one or more rechargeable or replaceable batteries. Switches 29 and 30 operate to turn the device ON or OFF and control the speed thereof, respectively.

It is preferred that the housing 12 be a one-piece unit, effectively sealed from the ingress (or egress) of fluids such as water or air. A one-piece construction is advantageous in allowing relatively simple, inexpensive manufacture with an airtight, waterproof seal that prolongs toothbrush life. Specifically, this seal not only protects the battery and working mechanisms from moisture, thereby improving reliability, but also enhances safety and prevents battery leakage outward from the unit. Each portion of the unit is preferably constructed of a polymeric material such as polyethylene. Alternatively or concurrently therewith, a shell construction of a conventional high-impact resistant plastic is also desirable for minimizing risk of damage during travel.

Movement of brush head 18 is controlled by variable, high-speed motor 24 housed suitably in the handle portion 14. In accordance with one aspect of the present invention, the brush head 18 is provided with soft, compact nylon bristles 20 formed in any shape. For example, bristles 20 can be provided in a cone-like shape that has not only been found highly effective for removing debris from between teeth, but also in cleaning between teeth and gums, rapid cleaning of the crown, as well as use on irregularly shaped teeth. Alternatively, the brush head 18 can have a flattened shape as depicted in FIG. 1. This arrangement has been found desirable for debris removal, polishing and gum messaging. In another embodiment, alternatively or concurrently with either of the foregoing brush head configurations, the brush head 18 can be detachably secured to the head portion such as by a snap fit for ready removal or replacement.

As indicated in FIG. 1, neck portion 16 can be generally fixed at a selected bend for orienting the brush head generally at an angle to the longitudinal axis of the toothbrush. Such angle can enhance better contact with the teeth through out the mouth of the user.

The neck portion 16 can be adjustably flexible, in whole or in part, for variable positioning of the brush head in a selected orientation relative to the handle portion. Selected adjustment is preferably facilitated by a universal joint and bearing assembly interior to the neck portion and a flex cord comprising the exterior neck portion (not shown). In this manner, a proper angle of the brush head relative to the teeth may be maintained for effective brushing. A flexible, bendable neck portion is also advantageous for placing the toothbrush in a stowed or folded position for storage, enhanced portability or the like. An example of a flexible neck portion is disclosed in U.S. Pat. No. 6,230,717 issued May 15, 2001, the entire content of which is herein incorporated by reference.

Motor 24 is preferably a conventional, low current DC motor with a capacity of at least three (3) volts, powered by a selected DC power source, e.g. batteries 27, 28. An objective is to provide selected constant, high speed movement with minimal slow down upon contact with the teeth or gums Suitability of other relatively low current motors will be appreciated by those skilled in the art, giving consideration to the purpose for which the present invention is intended.

The power source can be provided by one or more batteries 27, 28 as shown in FIG. 1. Any known type of power source can be used to operate motor 24 such as for an electric toothbrush as is well known in the art. The batteries can be disposable or rechargeable and are generally leak proof in that the have a relatively long life. For example, rechargeable batteries of nickel-cadmium, nickel metal hydride and lithium type can be used. Conventional replaceable alkaline batteries can also be used as the power source.

The variable speed, power control device for actuating movement of the brush plate 22 and/or bristles 20 can be provided by separate switches 29 and 30 as shown in FIG. 1 or can be provided as a multi-position pivot switch which may be actuated in at least two power settings. If three-position switch is used, according to one embodiment, the switch has a first position corresponding to a first or LOW power setting, a second setting corresponding to a second or HIGH power setting, and a third setting to a power OFF position. Each power setting, in turn, corresponds to a selected brush head speed, for instance, the LOW power setting corresponding to a first brush head speed and the HIGH setting to a second brush head speed. Alternatively, a conventional sliding type multi-position switch may be used. If two separate switches as shown in FIG. 1 are used, one switch 29 can be used to turn the motor ON or OFF, while switch 30 can be used for selecting the LOW or HIGH power settings.

An electronic circuit 32 used to adjust the speed of the 2-Speed motor of the present invention is shown in FIG. 2. The circuit 32 includes a DC motor 24, power sources 27 and 28 represented by 1.5 volt batteries, and switches 29 and 30 which represent an ON/OFF switch and a HIGH/LOW switch, respectively. Again, power sources 27 and 28 can be provided as a single battery source, if desired. When switch 29 is in the ON position and switch 32 is closed, as represented by “speedy” as shown in FIG. 2, the circuit is closed and the HIGH speed of motor 24 is activated to move the bristles 20 at a higher oscillation or rotation, depending on the particular configuration of the brush head 18. When switch 29 is in the ON position and switch 30 is on SLOW speed, the circuit is completed by passage through a diode 34 which reduces the voltage through the circuit to motor 24 by approximately ⅓. Since the voltage drop through diode 34 is not dependant on the amount of current through the circuit, a consistent low speed can be achieved unlike the use of a resistor in which voltage drop across the resistor results in changes in current levels. A fuse 36 can be incorporated into circuit 32 for safety reasons so as to prevent excessive overheating.

Turning now to operation, a method is provided for cleaning a user's teeth using a motorized toothbrush. Initially, a head portion of the toothbrush is inserted in the user's mouth. Next, the ON switch 29 is activated and a speed setting is selected by the user through switch 30. The motor 24 in the handle portion is then engaged thereby at the high or low speed. Oscillation or rotation of the brush head is effected by rotation of the motor 24. The moving brush head is then placed in contact with at least one of the user's teeth for a selected time. When a desired degree of cleaning has been achieved, the head portion is removed from the user's mouth, and the motor is disengaged by use of the OFF switch 29.

What is claimed is:

1. A circuit for a variable speed motor comprising a variable speed motor, a power source to provide a voltage to said motor and means to provide a voltage drop within said circuit and reduce the motor speed, wherein said means to provide said voltage drop is substantially independent of the amount of current to the motor.

2. The circuit of claim 1 wherein said means to provide a voltage drop and a reduction in motor speed is a diode.

3. The circuit of claim 1 wherein the variable speed motor is a 2-speed motor.

4. The circuit of claim 1 wherein said power source is in the form of at least one battery.

5. The circuit of claim 4 wherein said at least one battery is a rechargeable battery.

6. The circuit of claim 1 including an on/off switch to provide current to said variable speed motor from a power source and a variable speed switch to control the speed of said motor.

7. An electric toothbrush containing a variable speed motor, a brush plate supported on one end of said toothbrush and moveable by oscillation or rotation and a linkage from said variable speed motor to said brush plate to cause said oscillation or rotation of said brush plate and an electrical circuit for providing current to said variable speed motor to control the speed of said motor, means to provide a voltage drop and reduce the motor speed, said means to provide said voltage drop being substantially independent of the electrical current to said motor.

8. The electric toothbrush of claim 7 containing a handle portion, a neck portion, and a brush head portion wherein said variable speed motor is placed in said handle portion.

9. The electric toothbrush of claim 7 wherein means to provide said voltage drop is a diode.

10. The electric toothbrush of claim 7 wherein the variable speed motor is powered by at least one replaceable or rechargeable battery.
